(19) United States
(12) Patent Application Publication
(10) Pub. No.: US 2006/0125975 A1
(43) Pub. Date: Jun. 15, 2006

(54) Liquid crystal display device with two liquid crystal panels

(75) Inventors: Che Kuei Mai, Miao-Li (TW); Hong Han, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/301,042

(22) Filed: Dec. 12, 2005

(30) Foreign Application Priority Data
Dec. 10, 2004 (TW) 93219895

(51) Int. Cl. G02F 1/1335

(52) U.S. Cl. 349/62

(57) ABSTRACT

An LCD device (2) includes a first liquid crystal panel (110), a second liquid crystal panel (120), and a backlight module (130). The backlight module includes a light source (131), a light guide plate (132), a first set of optical films (133), and a second set of optical films (134). The light guide plate includes a light incident surface (135), a first light-emitting surface (136), and a second light-emitting surface (137). The light source is disposed adjacent to the light incident surface. The first set of optical films is disposed between the light guide plate and the first liquid crystal panel, and the second set of optical films is disposed between the light guide plate and the second liquid crystal panel. A plurality of dots (148) is formed at the second set of optical films, to enable the LCD device to provide a high quality display effect.

### FIELD OF THE INVENTION

The present invention relates to liquid crystal display (LCD) devices, and more particularly to a double-sided LCD device.

### BACKGROUND

LCD devices typically have high definition and multicolor display characteristics, as well as low power consumption, low voltage requirements, and light weight. These features make LCD devices a leading display device in the marketplace. LCD devices have been used for several years as mobile information displays in personal digital assistants (PDAs), portable computers, mobile phones, and the like.

Recently, a new type of folding mobile phone has been developed. By taking advantage of advances in fabrication techniques, the folding mobile phone is able to utilize two individual LCDs. The LCDs are provided in the folding portion (or upper housing) of the mobile phone, with rear surfaces of the LCDs being in contact with each other. Accordingly, data and images can be displayed on outer and inner surfaces of the upper housing. Thereby, a double-sided display function is achieved.

As shown in FIG. 8, a typical double-sided LCD device 1 includes a larger first liquid crystal panel 10, a smaller second liquid crystal panel 20, and a backlight module 30 disposed between the first and second liquid crystal panels 10, 20.

The first liquid crystal panel 10 includes a first substrate 11, a second substrate 12, and a first liquid crystal layer 13 contained between the first and second substrates 11, 12. The second liquid crystal panel 20 includes a third substrate 21, a fourth substrate 22, and a second liquid crystal layer 23 contained between the third and fourth substrates 21, 22. The first liquid crystal panel 10 has a larger display area than that of the second liquid crystal panel 20. The first liquid crystal panel 10 is defined as a primary screen, and the second liquid crystal panel 20 is defined as a secondary screen.

The backlight module 30 includes a light source 31, a light guide plate 32, a first set of optical films 33, and a second set of optical films 34. The light guide plate 32 includes a light incident surface 35, a first light-emitting surface 36 generally perpendicular to the light incident surface 35, and a second light-emitting surface 37 opposite to the first light-emitting surface 36. The light source 31 is disposed adjacent to the light incident surface 35. The first liquid crystal panel 10 is disposed adjacent to the first light-emitting surface 36, and the second liquid crystal panel 20 is disposed adjacent to the second light-emitting surface 37.

The first set of optical films 33 is disposed between the light guide plate 32 and the first liquid crystal panel 10. The first set of optical films 33 includes a first diffuser 41, a first brightness enhancement film 42, and a second brightness enhancement film 43, which are stacked in that order on the first light-emitting surface 36.

The second set of optical films 34 has a same area as that of the second liquid crystal panel 20, and is disposed between the light guide plate 32 and the second liquid crystal panel 20. The second set of optical films 34 includes a second diffuser 44, a third brightness enhancement film 45, and a fourth brightness enhancement film 46, which are disposed in that order on the second light-emitting surface 37. A peripheral reflector 47 and the second diffuser 44 cooperatively cover the entire second light-emitting surface 37.

In operation, light beams output by the light source 31 enter the light guide plate 32, and then emit from the first and second light-emitting surfaces 36, 37. A portion of the light beams transmitted to the second light-emitting surface 37 reach the second liquid crystal panel 20 through the second set of optical films 34, and the remaining portion of the light beams transmitted to the second light-emitting surface 37 are reflected by the reflector 47 to output from the first light-emitting surface 36. Light beams emitted from the first light-emitting surface 36 are used for illuminating the first liquid crystal panel 10. The light beams emitted from the second set of optical films 34 are used for illuminating the second liquid crystal panel 20. In this way, the LCD device 1 has a double-sided emitting function.

In the above-described configuration, the second set of optical films 34 is disposed at a center portion of the second light-emitting surface 37, and the reflector 47 is disposed to surround the second set of optical films 34. Therefore, the display area of the first liquid crystal panel 10 corresponding to the reflector 47 has a greater brightness than the display area of the first liquid crystal panel 10 corresponding to the center portion of the second light-emitting surface 37. Accordingly, the LCD device 1 does not produce a uniform brightness over the entire display area of the first liquid crystal panel 10.

Therefore, what is needed is an LCD device which can overcome the above-described problems.

### SUMMARY

An LCD device includes a first liquid crystal panel, a second liquid crystal panel, and a backlight module. The first liquid crystal panel has a larger display area than that of the second liquid crystal panel, and the backlight module is disposed between the first liquid crystal panel and the second liquid crystal panel. The backlight module includes a light source, a light guide plate, a first set of optical films, and a second set of optical films. The light guide plate includes a light incident surface, a first light-emitting surface, and a second light-emitting surface. The light source is disposed adjacent to the light incident surface. The first set of optical films is disposed between the light guide plate and the first liquid crystal panel, and the second set of optical films is disposed between the light guide plate and the second liquid crystal panel. A plurality of dots are formed at the second set of optical films.

With the dots formed at the second set of optical films, light beams emitting from the first light-emitting surface uniformly illuminate the first liquid crystal panel, and light beams emitting from the second light-emitting surface uniformly illuminate the second liquid crystal panel. Therefore, the LCD device provides a high quality display effect.

Other advantages and novel features will become more apparent from the following detailed description when taken in conjunction with the accompanying drawings.

### BRIEF DESCRIPTION OF THE DRAWINGS

FIG. 1 is a schematic, exploded, side cross-sectional view of an LCD device according to a first embodiment of the present invention.

FIG. 2 is a schematic, exploded, side cross-sectional view of an LCD device according to a second embodiment of the present invention.

FIG. 3 is a schematic, exploded, side cross-sectional view of an LCD device according to a third embodiment of the present invention.

FIG. 4 is a schematic, exploded, side cross-sectional view of an LCD device according to a fourth embodiment of the present invention.

FIG. 5 is a schematic, exploded, side cross-sectional view of an LCD device according to a fifth embodiment of the present invention.

FIG. 6 is a schematic, exploded, side cross-sectional view of an LCD device according to a sixth embodiment of the present invention.

FIG. 7 is a schematic, exploded, side cross-sectional view of an LCD device according to a seventh embodiment of the present invention.

FIG. 8 is a schematic, exploded, side cross-sectional view of a conventional LCD device.

### DETAILED DESCRIPTION OF PREFERRED EMBODIMENTS

FIG. 1 is a schematic, exploded, side cross-sectional view of an LCD device according to a first embodiment of the present invention. The LCD device 2 includes a first liquid crystal panel 110, a second liquid crystal panel 120, and a backlight module 130 disposed between the first and second liquid crystal panels 110, 120.

The first liquid crystal panel 110 includes a first substrate 111, a second substrate 112, and a first liquid crystal layer 113 contained between the first and second substrates 111, 112. The second liquid crystal panel 120 includes a third substrate 121, a fourth substrate 122, and a second liquid crystal layer 123 contained between the third and fourth substrates 121, 122. The first liquid crystal panel 110 has a larger display area than that of the second liquid crystal panel 120. The first liquid crystal panel 110 is defined as a primary screen and the second liquid crystal panel 120 is defined as a secondary screen.

The backlight module 130 includes a light source 131, a light guide plate 132, a first set of optical films 133, and a second set of optical films 134. The light guide plate 132 includes a light incident surface 135, a first light-emitting surface 136 generally perpendicular to the light incident surface 135, and a second light-emitting surface 137 opposite to the first light-emitting surface 136. The light source 131 is disposed adjacent to the light incident surface 135. The first liquid crystal panel 110 is disposed adjacent to the first light-emitting surface 136, and the second liquid crystal panel 120 is disposed adjacent to the second light-emitting surface 137.

The first set of optical films 133 is disposed between the light guide plate 132 and the first liquid crystal panel 110. The first set of optical films 133 includes a first diffuser 141, a first brightness enhancement film 142, and a second brightness enhancement film 143 stacked in that order on the first light-emitting surface 136.

The second set of optical films 134 has a same area as that of the second liquid crystal panel 120, and is disposed between the light guide plate 132 and the second liquid crystal panel 120. The second set of optical films 134 includes a second diffuser 144, a third brightness enhancement film 145, and a fourth brightness enhancement film 146, which are disposed in that order on the second light-emitting surface 137. A peripheral reflector 147 and the second diffuser 144 cooperatively cover the entire second light-emitting surface 137.

A plurality of dots 148 is formed on a surface of the second diffuser 144 that is adjacent to the light guide plate 132. The dots 148 are made of highly reflective resin such as polyethylene terephthalate or polyvinyl resin, and are formed on the surface of the second diffuser 144 by a printing method. In the illustrated embodiment, a pitch between adjacent dots 148 is constant. In alternative embodiments, the pitch between adjacent dots 148 can progressively decrease in radial directions away from a center of the array of dots 148. When light beams strike the dots 148, portions of the light beams are transmitted through the dots 148, and the remaining portions of the light beams are reflected and scattered by the dots 148.

In operation, light beams output by the light source 131 enter the light guide plate 132, and then emit from the first and second light-emitting surfaces 136, 137. A portion of the light beams exiting the second light-emitting surface 137 reach the second liquid crystal panel 120 through the dots 148 and through spaces between adjacent dots 148, and subsequently through the second set of optical films 134. A remaining portion of the light beams exiting the second light-emitting surface 137 are reflected by the reflector 147 and the dots 148, and subsequently emit from the first light-emitting surface 136. The light beams emitting from the first light-emitting surface 136 illuminate the first liquid crystal panel 110. Light beams emitting from the second set of optical films 134 illuminate the second liquid crystal panel 120. In this way, the LCD device 2 has a double-sided emitting function.

In the LCD device 2, some light beams are reflected and scattered by the dots 148 that correspond to the center portion of the first liquid crystal panel 110, and other light beams are reflected by the reflector 147. All these light beams cooperatively provide uniform illumination at the first light-emitting surface 136. Thus, light beams emitting from the first light-emitting surface 136 uniformly illuminate the first liquid crystal panel 110. Similarly, light beams emitting from the light-emitting surface 137 uniformly illuminate the second liquid crystal panel 120. Therefore, the LCD device 2 provides a high quality display effect.

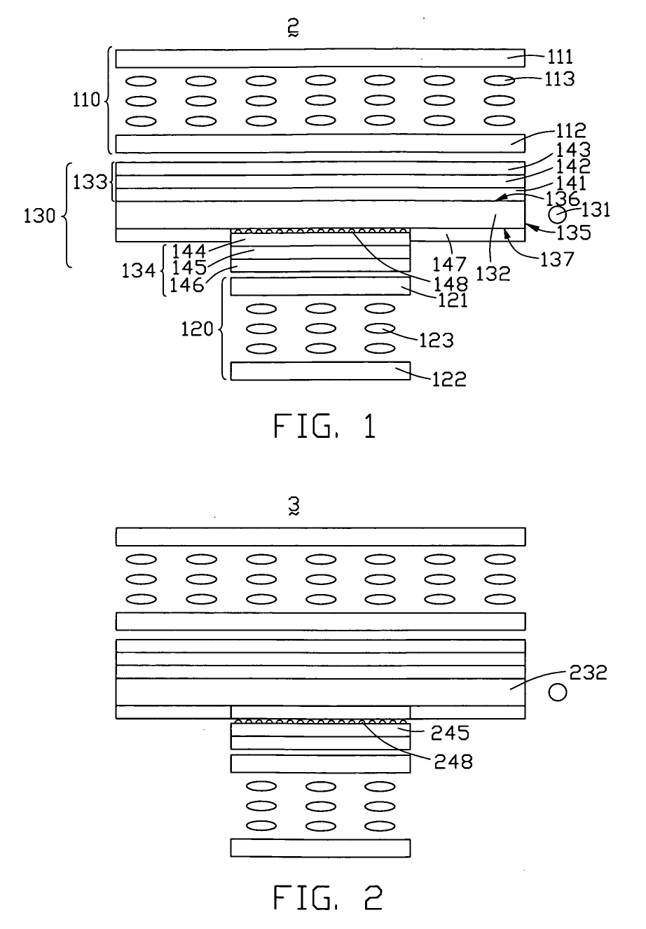

FIG. 2 is a schematic, exploded, side cross-sectional view of an LCD device according to a second embodiment of the present invention. The LCD device 3 has a structure similar to that of the LCD device 2. However, in the LCD device 3, a plurality of dots 248 are formed on a surface of a third brightness enhancement film 245 that is nearest to a light guide plate 232. The dots 248 are made of highly reflective resin such as polyethylene terephthalate or polyvinyl resin, and are formed on the surface of the third brightness enhancement film 245 by a printing method. In the illustrated embodiment, a pitch between adjacent dots 248 is constant. In alternative embodiments, the pitch between adjacent dots 248 can progressively decrease in radial directions away from a center of the array of dots 248. When light beams strike the dots 248, a portion of the light beams are transmitted through the dots 248, and the remaining portion of the light beams are reflected and scattered by the dots 248.

FIG. 3 is a schematic, exploded, side cross-sectional view of an LCD device according to a third embodiment of the present invention. The LCD device 4 has a structure similar to that of the LCD device 2. However, in the LCD device 4, a plurality of dots 348 are formed on a surface of a fourth brightness enhancement film 346 that is nearest to a light guide plate 332. The dots 348 are made of highly reflective resin such as polyethylene terephthalate or polyvinyl resin, and are formed on the surface of the fourth brightness enhancement film 346 by a printing method. In the illustrated embodiment, a pitch between adjacent dots 348 is constant. In alternative embodiments, the pitch between adjacent dots 348 can progressively decrease in radial directions away from a center of the array of dots 348. When light beams strike the dots 348, a portion of the light beams are transmitted through the dots 348, and the remaining portion of the light beams are reflected and scattered by the dots 348.

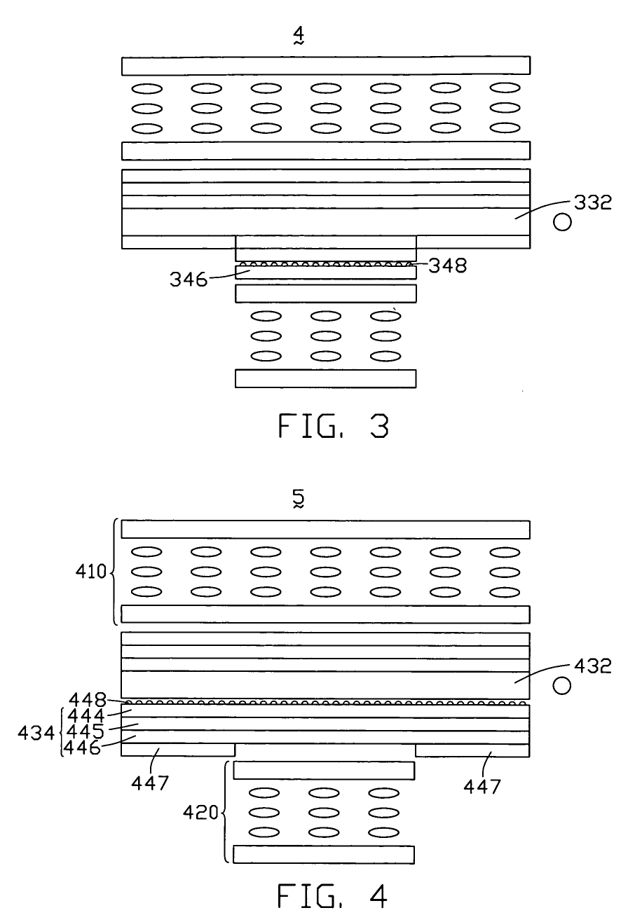

FIG. 4 is a schematic, exploded, side cross-sectional view of an LCD device according to a fourth embodiment of the present invention. The LCD device 5 has a structure similar to that of the LCD device 2. However, in the LCD device 5, a second set of optical films 434 has a same area as that of a first liquid crystal panel 410. The second set of optical films 434 includes a second diffuser 444, a third brightness enhancement film 445, and a fourth brightness enhancement film 446. A plurality of dots 448 are formed on a surface of the second diffuser 444 that is adjacent to a light guide plate 432. A peripheral reflector 447 is formed on a surface of the fourth brightness enhancement film 446 that is farthest from the light guide plate 432. The reflector 447 and a second liquid crystal panel 420 cooperatively cover an entire underside of the second set of optical films 434.

FIG. 5 is a schematic, exploded, side cross-sectional view of an LCD device according to a fifth embodiment of the present invention. The LCD device 6 has a structure similar to that of the LCD device 2. However, in the LCD device 6, a second set of optical films 534 includes a second diffuser 544, a third brightness enhancement film 545, and a fourth brightness enhancement film 546. The second diffuser 544 has a same area as that of a first liquid crystal panel 510. The third brightness enhancement film 545 and the fourth brightness enhancement film 546 each have a same area as that of a second liquid crystal panel 520. A plurality of dots 548 are formed on a surface of the second diffuser 544 that is adjacent to a light guide plate 532. In the illustrated embodiment, a pitch between adjacent dots 548 is constant. In alternative embodiments, the pitch between adjacent dots 548 can progressively decrease in radial directions away from a center of the array of dots 548. A peripheral reflector 547 is formed on a surface of the second diffuser 544 that is farthest from the light guide plate 532. The reflector 547 and the third brightness enhancement film 545 cooperatively cover an entire underside of the second diffuser 544.

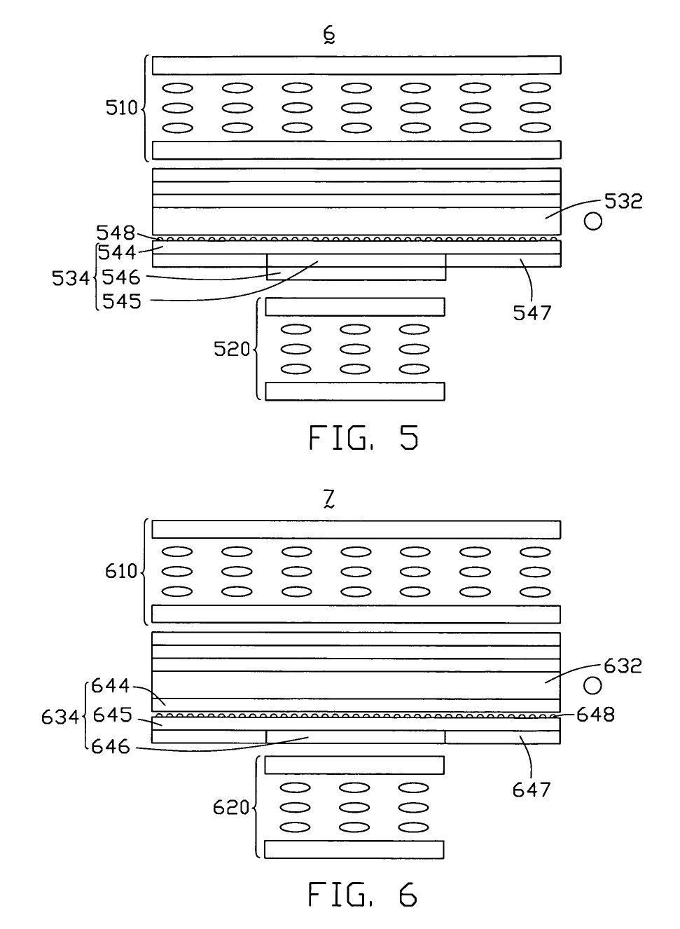

FIG. 6 is a schematic, exploded, side cross-sectional view of an LCD device according to a sixth embodiment of the present invention. The LCD device 7 has a structure similar to that of the LCD device 2. However, in the LCD device 7, a second set of optical films 634 includes a second diffuser 644, a third brightness enhancement film 645, and a fourth brightness enhancement film 646. The second diffuser 644 and the third brightness enhancement film 645 each have a same area as that of a first liquid crystal panel 610. The fourth brightness enhancement film 646 has a same area as that of a second liquid crystal panel 620. A plurality of dots 648 are formed on a surface of the third brightness enhancement film 645 that is nearest to a light guide plate 632. In the illustrated embodiment, a pitch between adjacent dots 648 is constant. In alternative embodiments, the pitch between adjacent dots 648 can progressively decrease in radial directions away from a center of the array of dots 648. A peripheral reflector 647 is formed on a surface of the third brightness enhancement film 645 that is farthest from the light guide plate 632. The reflector 647 and the fourth brightness enhancement film 646 cooperatively cover an entire underside of the third brightness enhancement film 645.

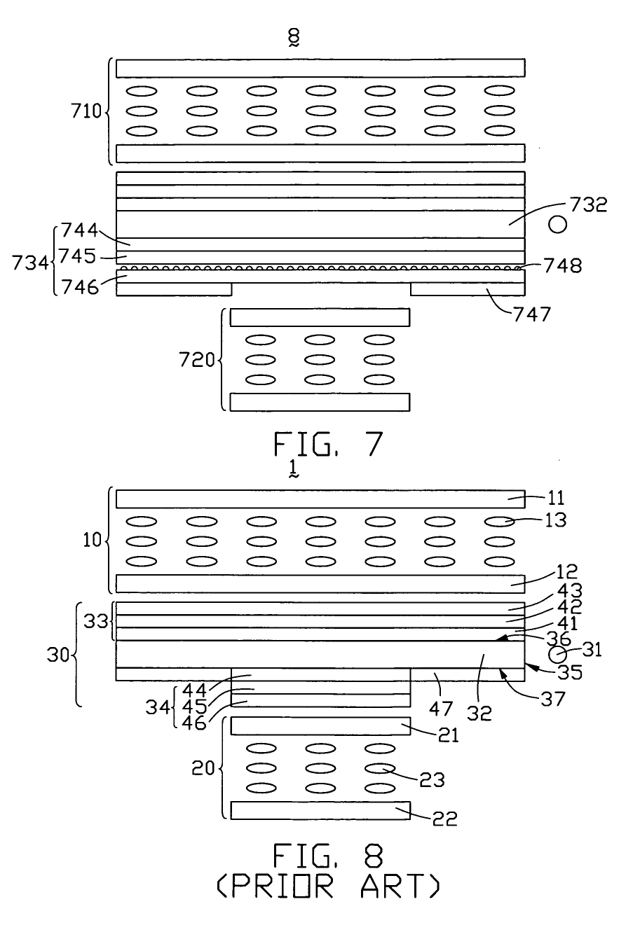

FIG. 7 is a schematic, exploded, side cross-sectional view of an LCD device according to a seventh embodiment of the present invention. The LCD device 8 has a structure similar to that of the LCD device 2. However, in the LCD device 8, a second set of optical films 734 includes a second diffuser 744, a third brightness enhancement film 745, and a fourth brightness enhancement film 746. The second set of optical films 734 has a same area as that of a first liquid crystal panel 710. A plurality of dots 748 are formed on a surface of the fourth brightness enhancement film 746 that is nearest to a light guide plate 732. In the illustrated embodiment, a pitch between adjacent dots 748 is constant. In alternative embodiments, the pitch between adjacent dots 748 can progressively decrease in radial directions away from a center of the array of dots 748. A peripheral reflector 747 is formed on a surface of the fourth brightness enhancement film 746 that is nearest to the light guide plate 732. The reflector 747 and a second liquid crystal panel 720 cooperatively cover an entire underside of the second set of optical films 734.

In various and further embodiments of the present invention, a shape of the dots can be hemispherical, partially hemispherical, dome-shaped, or pyramidal, with a base profile of the shape being circular, elliptical, square, triangular, rectangular, or polygonal. The dots can be made from a material which has a same reflectivity as the reflector.

In the above-described LCD devices, a plurality of dots are formed at the second set of optical films. Hence, light beams emitting from the first light-emitting surface uniformly illuminate the first liquid crystal panel, and light beams emitting from the second light-emitting surface uniformly illuminate the second liquid crystal panel. Therefore, the LCD devices provide a high quality display effect.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display device, comprising:
a first liquid crystal panel and a second liquid crystal panel, the first liquid crystal panel having a larger display area than that of the second liquid crystal panel; and
a backlight module disposed between the first liquid crystal panel and the second liquid crystal panel, the backlight module comprising a light source, a light guide plate, a first set of optical films, and a second set of optical films;
wherein the light guide plate comprises a light incident surface, a first light-emitting surface, and a second light-emitting surface, the light source is disposed adjacent to the light incident surface, the first set of optical films is disposed between the light guide plate and the first liquid crystal panel, the second set of optical films is disposed between the light guide plate and the second liquid crystal panel, and a plurality of dots are provided at the second set of optical films.

2. The liquid crystal display device as claimed in claim 1, wherein the first liquid crystal panel is defined as a primary screen and the second liquid crystal panel is defined as a secondary screen.

3. The liquid crystal display device as claimed in claim 1, further comprising a reflector, wherein the reflector and the second set of optical films cooperatively cover the second light-emitting surface.

4. The liquid crystal display device as claimed in claim 1, wherein the first set of optical films comprises a first diffuser, a first brightness enhancement film, and a second brightness enhancement film disposed in that order on the first light-emitting surface.

5. The liquid crystal display device as claimed in claim 4, wherein the second set of optical films comprises a second diffuser, a third brightness enhancement film, and a fourth brightness enhancement film disposed in that order on the second light-emitting surface.

6. The liquid crystal display device as claimed in claim 5, wherein the dots are formed on a surface of the second diffuser adjacent to the light guide plate.

7. The liquid crystal display device as claimed in claim 5, wherein the dots are formed on a surface of the third brightness enhancement film nearest to the light guide plate.

8. The liquid crystal display device as claimed in claim 5, wherein the dots are formed on a surface of the fourth brightness enhancement film nearest to the light guide plate.

9. The liquid crystal display device as claimed in claim 1, further comprising a reflector formed on an outer surface of the second set of optical films, wherein the reflector and the second liquid crystal panel cooperatively cover the second set of optical films.

10. The liquid crystal display device as claimed in claim 9, wherein the first set of optical films comprises a first diffuser, a first brightness enhancement film, and a second brightness enhancement film disposed in that order on the first light-emitting surface.

11. The liquid crystal display device as claimed in claim 10, wherein the second set of optical films comprises a second diffuser, a third brightness enhancement film, and a fourth brightness enhancement film disposed in that order on the second light-emitting surface.

12. The liquid crystal display device as claimed in claim 11, wherein the dots are formed on a surface of the second diffuser adjacent to the light guide plate.

13. The liquid crystal display device as claimed in claim 11, wherein the dots are formed on a surface of the third brightness enhancement film nearest to the light guide plate.

14. The liquid crystal display device as claimed in claim 11, wherein the dots are formed on a surface of the fourth brightness enhancement film nearest to the light guide plate.

15. A liquid crystal display device, comprising:
a first liquid crystal panel and a second liquid crystal panel, the first liquid crystal panel having a larger display area than that of the second liquid crystal panel; and
a backlight module disposed between the first liquid crystal panel and the second liquid crystal panel, the backlight module comprising a light source, a light guide plate, a first set of optical films, and a second set of optical films;
wherein the light guide plate comprises a light incident surface, a first light-emitting surface, and a second light-emitting surface, the light source is disposed adjacent to the light incident surface, the first set of optical films is disposed between the light guide plate and the first liquid crystal panel, the second set of optical films is disposed between the light guide plate and the second liquid crystal panel, and a plurality of dots are provided between the second liquid crystal panel and the light guide plate.
